(19) United States
(12) Patent Application Publication
(10) Pub. No.: US 2021/0312716 A1
(43) Pub. Date: Oct. 7, 2021

(54) METHODS AND SYSTEMS TO CREATE A CONTROLLER IN AN AUGMENTED REALITY (AR) ENVIRONMENT USING ANY PHYSICAL OBJECT

(71) Applicant: Intuit Inc., Mountain View, CA (US)

(72) Inventors: Yuhua Xie, Walnut Creek, CA (US); Phouphet Sihavong, San Jose, CA (US); Roger Meike, Redwood City, CA (US)

(73) Assignee: Intuit Inc., Mountain View, CA (US)

(21) Appl. No.: 17/348,022

(22) Filed: Jun. 15, 2021

Related U.S. Application Data
(63) Continuation of application No. 16/730,019, filed on Dec. 30, 2019.

(51) Int. Cl. G06T 19/00; G06T 19/20

(52) U.S. Cl. CPC G06T 19/006; G06T 19/20; G06T 2219/2012; G06T 2219/2016; G06T 2219/2021

(57) ABSTRACT

A system detects one or more features of a physical object located in a real-world space based on images or video of the physical object captured by an image capture device, designates the physical object as a controller of the VR environment, and determines an orientation of the physical object in the real-world space based on the captured images or video without receiving control signals or communications from the physical object. The system generates, in the VR environment, a virtual object representative of the physical object based on the orientation and the one or more detected features of the physical object. The system detects a gesture associated with the physical object in the real-world space based on the captured images or video, and changes a position or orientation of the virtual object in the VR environment based on the detected gesture.

### CROSS-REFERENCE TO RELATED APPLICATIONS

This Patent Application is a Continuation Application of and claims priority to U.S. patent application Ser. No. 16/730,019 entitled “METHODS AND SYSTEMS TO CREATE A CONTROLLER IN AN AUGMENTED REALITY (AR) ENVIRONMENT USING ANY PHYSICAL OBJECT” and filed on Dec. 30, 2019, which is assigned to the assignee hereof. The disclosures of all prior Applications are considered part of and are incorporated by reference in this Patent.

### TECHNICAL FIELD

This disclosure relates generally to augmented reality (AR) systems, and more specifically, to manipulating a virtual object in a virtual reality environment using a physical object in a real-world space.

### DESCRIPTION OF RELATED ART

Simplifying human interaction with a digital interface, such as a computer, is a key feature of any modern electronic device. Users typically rely upon conventional data input peripherals (such as computer mice, touchpads, keyboards, and the like) to interact with electronic devices. In view of recent technological advances from two-dimensional (2D) computing to fully immersive three-dimensional (3D) AR or mixed reality (MR) environments, conventional data input peripherals may be inadequate to meet the needs of AR or MR environments. Conventional data input peripherals may impede or diminish fully immersive user experiences in 3D AR or 3D MR environments, for example, due to the 2D nature of such conventional data input peripherals.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods and devices of this disclosure each have several innovative aspects, no single one of which is solely responsible for the desirable attributes disclosed herein.

One innovative aspect of the subject matter described in this disclosure can be implemented as a method for generating a virtual reality (VR) environment. The method can be performed by one or more processors of a system, and can include detecting one or more features of a physical object located in a real-world space based on images or video of the physical object captured by an image capture device, designating the physical object as a controller of the VR environment, and determining an orientation of the physical object in the real-world space based on the captured images or video without receiving control signals or communications from the physical object. The method may include generating, in the VR environment, a virtual object representative of the physical object based on the orientation and the one or more detected features of the physical object. The method may include detecting a gesture associated with the physical object in the real-world space based on the captured images or video without receiving control signals or communications from the physical object, and changing a position or orientation of the virtual object in the VR environment based on the detected gesture. In some instances, the physical object is incapable of transmitting signals or communications to the system.

In various implementations, generating the virtual object includes presenting the virtual object on a display screen viewable by a user associated with the physical object. In some implementations, the method may also include determining that the detected gesture is a swiping gesture, and moving the virtual object off the display screen in response to the swiping gesture. In some instances, the method may also include associating the virtual object with one or more software programs executing on the system, and closing the one or more executing software programs in response to the swiping gesture. In other implementations, the method may include determining that the detected gesture is a circular gesture, and moving the virtual object in a circle around the display screen in response to the circular gesture.

In some other implementations, the method may include changing the position or orientation of the virtual object presented on the display screen based on the detected gesture. In some instances, the virtual object is a virtual pointer, and the method also includes presenting a continuous spectrum of colors in a circular orientation on the display screen, moving the virtual pointer around the continuous spectrum of colors on the display screen based on the detected gesture, and selecting a color of the continuous spectrum of colors based on the movement of the virtual pointer around the continuous spectrum of colors.

In some implementations, the method can also include associating the physical object with a user, and compensating for movement of the image capture device, concurrently with changing the position or orientation of the virtual object in the VR environment, in response to one or more parameters provided by the user. In addition, or in the alternative, the method can also include receiving, from a user, one or more values defining a relationship between detected movements of the physical object in the real-world space and movements of the virtual object in the VR environment, and manipulating the virtual object in the VR environment based at least in part on the relationship.

Another innovative aspect of the subject matter described in this disclosure can be implemented in a system for generating a VR environment. In some implementations, the system includes an image capture device, one or more processors, and a memory. The image capture device can be configured to capture images or video of a physical object located in a real-world space. The memory stores instructions that, when executed by the one or more processors, causes the system to detect one or more features of a physical object located in a real-world space based on images or video of the physical object captured by an image capture device, designate the physical object as a controller of the VR environment based on the detected features of the physical object, and determine an orientation of the physical object in the real-world space based on the captured images or video without receiving control signals or communications from the physical object. Execution of the instructions also causes the system to generate, in the VR environment, a virtual object representative of the physical object based on the orientation and the one or more detected features of the physical object, to detect a gesture associated with the physical object in the real-world space based on the captured images or video without receiving control signals or communications from the physical object, and to change a position or orientation of the virtual object in the VR environment based on the detected gesture. In some instances, the physical object is incapable of transmitting signals or communications to the system.

In various implementations, generating the virtual object includes presenting the virtual object on a display screen viewable by a user associated with the physical object. In some implementations, execution of the instructions also causes the system to determine that the detected gesture is a swiping gesture, and to move the virtual object off the display screen in response to the swiping gesture. In some instances, execution of the instructions also causes the system to associate the virtual object with one or more software programs executing on the system, and to close the one or more executing software programs in response to the swiping gesture. In other implementations, execution of the instructions also causes the system to determine that the detected gesture is a circular gesture, and to move the virtual object in a circle around the display screen in response to the circular gesture.

In some other implementations, execution of the instructions also causes the system to change the position or orientation of the virtual object presented on the display screen based on the detected gesture. In some instances, the virtual object is a virtual pointer, and execution of the instructions also causes the system to present a continuous spectrum of colors in a circular orientation on the display screen, to move the virtual pointer around the continuous spectrum of colors on the display screen based on the detected gesture, and to select a color of the continuous spectrum of colors based on the movement of the virtual pointer around the continuous spectrum of colors.

In some implementations, execution of the instructions also causes the system to associate the physical object with a user, and to compensate for movement of the image capture device, concurrently with changing the position or orientation of the virtual object in the VR environment, in response to one or more parameters provided by the user. In addition, or in the alternative, execution of the instructions also causes the system to receive, from a user, one or more values defining a relationship between detected movements of the physical object in the real-world space and movements of the virtual object in the VR environment, and to manipulate the virtual object in the VR environment based at least in part on the relationship.

### BRIEF DESCRIPTION OF THE DRAWINGS

Implementations of the subject matter disclosed herein are illustrated by way of example and are not intended to be limited by the figures of the accompanying drawings. Note that the relative dimensions of the following figures may not be drawn to scale.

FIG. 1 shows a block diagram of an augmented reality (AR) system, according to some implementations.

FIG. 2 shows a schematic representation of an AR system, according to some implementations.

FIG. 3 shows example representations of cartesian, cylindrical, and spherical coordinate systems, according to some implementations.

FIG. 4 shows an example process flow of an AR system, according to some implementations.

FIG. 5 shows an example color wheel that can be used to select colors using a voice-based AR system.

FIG. 6 shows an example color map that can be used to select or change the color of a virtual object, according to some implementations.

FIGS. 7A-7G show illustrative flowcharts depicting example operations for manipulating a virtual object in a virtual reality (VR) environment, according to some implementations.

FIG. 7H shows an illustrative flowchart depicting example operations for manipulating one or more target objects in the real world, according to some implementations.

FIG. 8 shows an example audio taper plot, according to some implementations.

FIGS. 9A-9B show illustrations depicting an example operation for manipulating a virtual object, according to some implementations.

Like numbers reference like elements throughout the drawings and specification.

### DETAILED DESCRIPTION

Various implementations of the subject matter disclosed herein relate generally to an augmented reality (AR) system that can generate a digital representation of a physical object in an entirely virtual space (such as a VR environment). The digital representation, referred to herein as a “virtual object,” can be presented on a display screen (such as a computer monitor or television), or can be presented in a fully immersive 3D virtual environment. Some implementations more specifically relate to AR systems that allow one or more virtual objects presented in a VR environment to be manipulated or controlled by a user-selected physical object without any exchange of signals or active communication between the physical object and the AR system. In accordance with some aspects of the present disclosure, an AR system can recognize the user-selected physical object as a controller, and capture images or video of the physical object controller while being moved, rotated, or otherwise manipulated by the user. The AR system can use the captured images or video to detect changes in position, orientation, and other movements of the physical object, including one or more gestures made by the user, and then manipulate the virtual object based at least in part on the detected movements and/or gestures. As such, the various AR systems disclosed herein do not require any pairing, training, or calibration of physical objects selected by the user to manipulate or control virtual objects presented in the VR environment. Moreover, because the AR systems disclosed herein allow physical objects to manipulate or control virtual objects without any exchange of signals or active communication, a user can select any one of a wide variety of physical objects commonly found at the user's home or work to use as a controller for manipulating or controlling virtual objects presented in a VR environment. Example objects that can be used as controllers for the AR systems disclosed herein can be ordinary non-electronic items or objects including (but not limited to) a book, a magazine, rolled-up newspaper, a playing card, a glass, a plate, a bottle, a ball, a toy car, a utensil, a throw-pillow, a paperweight, a hand or fingers, and so on.

More specifically, the AR system can detect one or more features of a physical object selected by the user based at least in part on images or video of the physical object captured by an image capture device, and can use the detected features to recognize or designate the physical object as a controller for the AR system. The AR system can use any suitable features of the physical object for recognizing and designating the physical object as the controller. For one example, the AR system may detect the size, shape, and appearance of a rolled-up magazine that was previously used as a controller, and may authenticate the rolled-up magazine as the physical object controller for the AR system based on the detected size, shape, and appearance of the rolled-up magazine. For another example, the AR system may detect the size, shape, and certain letters or designs on a playing card (such as the Queen of Spades) that was previously used as a controller, and may authenticate the playing card as the physical object controller for the AR system based on the detected size, shape, and certain letters or designs on the playing card.

After the physical object is recognized as a controller, the AR system can use images or video of the physical object controller to determine a position of the physical object controller, an orientation of the physical object controller, movements of the physical object controller, and gestures made by a user with the physical object controller. The AR system can generate a virtual object representative of the physical object controller based at least in part on the detected features, position, movements, and/or orientation of the physical object, and can present the virtual object in the VR environment. The AR system can detect movement of the physical object based at least in part on the captured images or video, and can manipulate the virtual object in the VR environment based at least in part on the detected movements of the physical object controller. In some implementations, movement of the physical object in the real-world space can be a gesture, and the AR system can change one or more of a position of the virtual object, an orientation of the virtual object, a shape of the virtual object, or a color of the virtual object based at least in part on the gesture performed using the physical object. In other implementations, movement of the physical object can include one or more of a change in position, a change in shape, or a change in orientation of the physical object in the real-world space, and the AR system can manipulate the virtual object by changing one or more of a position of the virtual object, an orientation of the virtual object, a shape of the virtual object, or a color of the virtual object based at least in part on the detected movement of the physical object.

Accordingly, implementations of the subject matter disclosed herein provide systems, methods, and apparatuses that can transform non-electronic objects or items commonly found at a user's home or work into controllers with which the user can manipulate or control one or more virtual objects presented in a VR environment. For example, a user can pick up a nearby book, position the book in the field of view (FOV) of the image capture device until its presence is detected and recognized as a controller, and then move, rotate, and/or make gestures with the book to move, rotate, or change various visual, audible, and physical characteristics of virtual objects presented in the VR environment.

Various implementations of the subject matter disclosed herein provide one or more technical solutions to the technical problem of transforming ordinary non-electronic physical objects into a controller of a virtual object presented in a VR or MR environment. The controller can be used to manipulate or alter various properties and characteristics of the virtual object including (but not limited to) position, translation, rotation, movement, velocity, speed, coloration, tint, hue, sound emission, volume, rhythm, beats, etc., of the virtual object. More specifically, various aspects of the present disclosure provide a unique computing solution to a unique computing problem that did not exist prior to the creation of AR, VR, or MR environments, much less transforming a physical object incapable of transmitting or receiving signals into a controller with which a user can use to manipulate virtual objects presented in a VR environment. As such, implementations of the subject matter disclosed herein are not an abstract idea and/or are not directed to an abstract idea such as organizing human activity or a mental process that can be performed in the human mind. Moreover, various aspects of the present disclosure effect an improvement in the technical field of object recognition and tracking by allowing a user to provide threshold values that define various movement ratios between movement of the controller in the real-world space and the corresponding manipulation of the virtual object in the VR environment. These functions cannot be performed in the human mind, much less using pen and paper.

In the following description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. The term “manipulating” encompasses changing an orientation of the virtual object, changing a position of the virtual object, changing a shape or size of the virtual object, changing a color of the virtual object, changing a visual or audible characteristic of the virtual object, and changing any other feature of the virtual object. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory, and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may include random-access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the implementations disclosed herein may be executed by one or more processors. The term “processor,” as used herein may refer to any general-purpose processor, conventional processor, controller, microcontroller, and/or state machine capable of executing scripts or instructions of one or more software programs stored in memory.

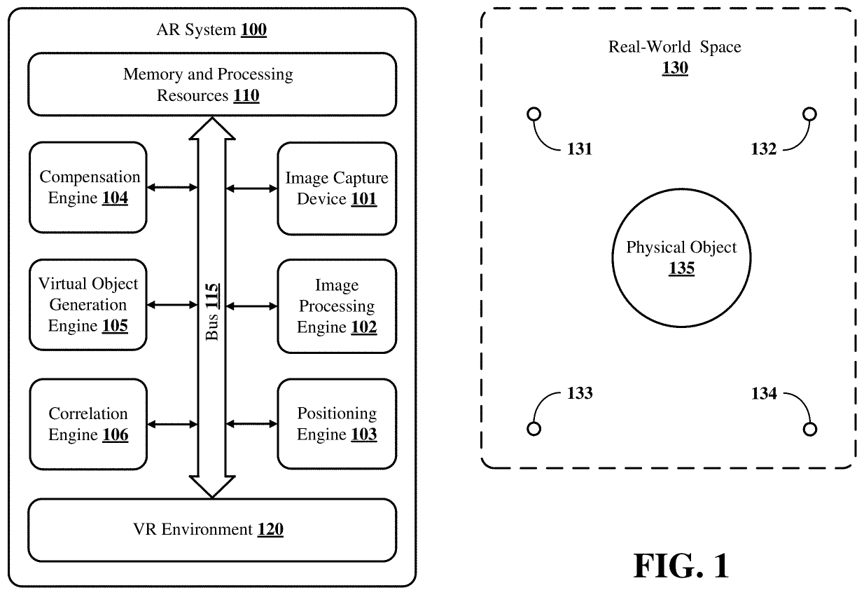

FIG. 1 shows a block diagram of an augmented reality (AR) system 100, according to some implementations. The AR system 100 may include an image capture device 101, an image processing engine 102, a positioning engine 103, a compensation engine 104, a virtual object generation engine 105, a correlation engine 106, memory and processing resources 110, and a VR environment 120. In some implementations, the various engines and components of the AR system 100 can be interconnected by at least a data bus 115, as depicted in the example of FIG. 1. In other implementations, the various engines and components of the AR system 100 can be interconnected using other suitable signal routing resources. The AR system 100 can be implemented using any suitable combination of software and hardware.

The AR system 100 may be associated with a real-world space 130 including at least a physical object 135. The real-world space 130 can be any suitable environment or area including (but not limited to) a building, room, office, closet, park, car, airplane, boat, and so on. The real-world space 130 is at least substantially stationary, which allows the AR system 100 to determine or assign positional coordinates to defined boundaries of the real-world space 130, as well as to any objects contained therein (such as the physical object 135). In some aspects, the real-world space 130 can be bounded by walls, decor, furniture, fixtures, and/or the like. A user (not shown in FIG. 1) can enter the real-world space 130 and interact with the AR system 100, for example, by using the physical object 135 as a controller to manipulate one or more aspects of virtual objects generated by the AR system 100.

The physical object 135 can be any suitable object that can be detected and tracked by the image capture device 101. For example, the physical object 135 can be a non-electronic object commonly found in the user's home or office such as, for example, a book, a magazine, a rolled-up newspaper, a playing card, a glass, a plate, a bottle, a ball, a toy car, a utensil, a throw-pillow, a paperweight, a hand or fingers, and so on. In accordance with various aspects of the present disclosure, the physical object 135 can be used to manipulate or control one or more virtual objects without transmitting signals to, or receiving signals from, the AR system 100 or the image capture device 101. In other words, the physical object 135 can be incapable of exchanging signals or actively communicating with any component of the AR system 100, and yet still operate as a controller with which users can manipulate or control virtual objects presented in the VR environment 120.

The image capture device 101 can be any suitable device that can capture images or video of the physical object 135. For example, the image capture device 101 can be a digital camera, a digital recorder, a sensor, or any other device that can detect one or more features of the physical object 135, detect changes in position or orientation of the physical object 135, and detect user gestures made with the physical object 135. In some implementations, the image capture device 101 can identify or recognize the physical object 135 as a controller with which users can manipulate various aspects of virtual objects presented in the VR environment 120. For example, the user may position the physical object 135 within the FOV of the image capture device 101, and the AR system 100 can designate the physical object 135 as a controller based on one or more features of the physical object 135 extracted from images or video captured by the image capture device 101.

The image processing engine 102, which can include one or more image signal processors (not shown for simplicity), can process images or video captured by the image capture device 101 and generate signals indicative of changes in position and orientation of the physical object 135. In addition, the image processing engine 102 can generate signals indicative of one or more detected features of the physical object 135, and can generate signals indicative of one or more user gestures made with the physical object 135. In some aspects, the image processing engine 102 may execute instructions from a memory to control operation of the image capture device 101 and/or to process images or video captured by the image capture device 101. In other implementations, the image processing engine 102 may include specific hardware to control operation of the image capture device 101 and/or to process the images or video captured by the image capture device 101.

The positioning engine 103 can determine the position and orientation of the physical object 135 in the real-world space 130, for example, based on captured images or video provided by the image capture device 101 and/or processed images or video provided by the image processing engine 102. The positioning engine 103 can also determine positional coordinates of the physical object 135 and one or more reference points 131-134 within the real-world space 130. In some aspects, the positional coordinates may be relative to the AR system 100 or to some other fixed object or point in the real-world space 130. In other aspects, the positional coordinates may be absolute coordinates determined by or received from a suitable GPS device. In some other aspects, the positioning engine 103 can attribute or assign coordinates to regions, surface areas, objects, and reference points within the real-world space 130 (such as the physical object 135 and reference points 131-134).

In some implementations, the positioning engine 103 can continuously (or at least with a minimum periodicity) process the images or video provided by the image capture device 101 to detect movement of the physical object 135. The movement can include changes in position of the physical object 135, changes in orientation of the physical object 135, or gestures made using the physical object 135. In some aspects, the positioning engine 103 can generate one or more vectors indicative of amounts by which the physical object 135 moved and/or rotated. By assigning positional coordinates to the physical object 135, to the one or more reference points 131-134, and/or to other locations in the real-world space 130, the AR system 100 can detect gestures and movements of the physical object 135 without training, pairing, or calibrating the physical object 135.

The compensation engine 104 can compensate for inadvertent or non-deliberate movements of the image capture device 101 by selectively adjusting perceived movements of the physical object 135 detected by the positioning engine 103. For example, if the user accidently bumps into the image capture device 101 and causes it to inadvertently move, even temporarily, the compensation engine 104 can determine an amount by which the image capture device 101 moved and then adjust the perceived movements of the physical object 135 based on the determined amount. In some implementations, the compensation engine 104 may facilitate the translation of the one or more reference points 131-134 in the real-world space 130 into one or more corresponding virtual reference points in the VR environment 120, for example, to ensure a seamless correlation between detected movements of the physical object 135 in the real-world space 130 and manipulation of virtual objects in the VR environment 120.

The compensation engine 104 can also compensate for erratic or difficult-to-follow movements of the physical object controller 135. In some implementations, the compensation engine 104 can use one or more tolerance parameters to identify movements of the physical object 135 that are erratic or difficult-to-follow (as opposed to movements of the physical object 135 intended by the user). In some aspects, the tolerance parameters can define ranges of a number of normal or non-erratic movements expected by the physical object 135. If movements of the physical object 135 detected by the positioning engine 103 fall within the defined ranges, the AR system 100 can determine that the detected movements are normal or intended, and may allow the detected movements of the physical object 135 to manipulate the virtual object presented in the VR environment 120 accordingly. Conversely, if movements of the physical object 135 detected by the positioning engine 103 fall outside the defined ranges, the AR system 100 may determine that the detected movements are erratic or unintended, and therefore ignore these detected movements. For example, if the user accidentally drops the physical object 135, the compensation engine 104 can determine that the corresponding movement of the physical object 135 falls outside of the defined ranges of movement, and can prevent such accidental movements of the physical object 135 from manipulating the virtual object.

The virtual object generation engine 105 can generate one or more virtual objects in the VR environment 120 based at least in part on the determined orientation and detected features of the physical object 135. In some implementations, the virtual object can be a virtual representation of the physical object 135. In other implementations, the virtual object can be a target object (such as a pointer) that can be used to manipulate or control other objects or devices. The virtual object can be created in any conceivable visual and/or audial form, including 2D and 3D representations, static images, moving imagery, icons, avatars, etc. The virtual object can also be represented as a sequence of flashing lights or pulsating sounds with no associated computer-based VR representation.

The correlation engine 106 can generate virtual coordinates of the virtual object in the VR environment 120 based at least in part on the positional coordinates of the physical object 135 in the real-world space 130, and can correlate the positional coordinates of the physical object 135 in the real-world space 130 with the virtual coordinates of the virtual object presented in the VR environment 120. The correlation engine 106 can also correlate the positional coordinates of the one or more reference points 131-134 in the real-world space 130 with corresponding virtual reference points in the VR environment 120. For example, when a user moves or rotates the physical object 135 in the real-world space 130, the correlation engine 106 can correlate the detected movement or rotation of the physical object 135 with movement or rotation of the virtual object in the VR environment 120.

The memory and processing resources 110 can include any number of memory elements and one or more processors (not shown in FIG. 1 for simplicity). The one or more processors can each include a processor capable of executing scripts or instructions of one or more software programs stored within associated memory resources. In some implementations, the processors can be one or more general purpose processors that execute instructions to cause the AR system 100 to perform any number of different functions or operations. In addition, or in the alternative, the processors can include integrated circuits or other hardware to perform functions or operations without the use of software. The memory elements can be any suitable type of memory, and can include non-volatile memory and volatile memory components. In some implementations, the memory resources can include a non-transient or non-transitory computer readable medium configured to store computer-executable instructions that can be executed by the one or more processors to perform all or a portion of one or more operations described in this disclosure.

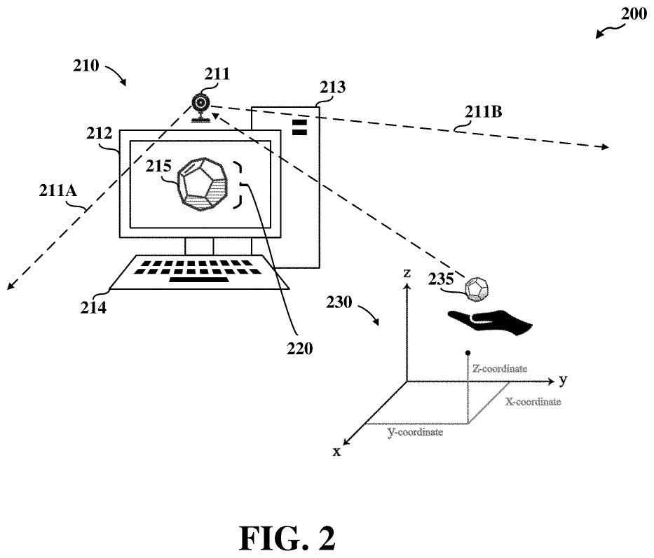

FIG. 2 shows a schematic representation of an AR system 200, according to some implementations. The AR system 200, which may be an example of at least part of the AR system 100 of FIG. 1, includes a computer system 210 having at least an image capture device 211, a display screen 212, processing resources 213, and an I/O interface 214. Although depicted in FIG. 2 as a keyboard, the I/O interface 214 can be (or include) any suitable components that allow a user to interact with the AR system 200. In some aspects, the user may provide parameters, attributes, preferences, taper relationships, and other information to the AR system 200 via the I/O interface 214. The image capture device 211 can detect and identify a physical object 235 located within its FOV depicted by dashed lines 211A and 211B. The computer system 210 can generate one or more virtual objects 215 for presentation in a VR environment 220 provided by the display screen 212 (only one virtual object 215 shown for simplicity). Although depicted in the example of FIG. 2 as presented on the display screen 212, the virtual object 215 can be presented on other suitable displays including, for example, VR glasses, goggles, or headsets. The computer system 210 can also manipulate the virtual object 215 based on detected movements of the physical object 235 in the real-world space 230, for example, as described with respect to FIG. 1.

The AR system 200 can designate the physical object 235 as a controller based on one or more detected features. Once so designated, the physical object controller 235 can be used to manipulate or control various aspects of the virtual object 215 presented in the VR environment 220. The virtual object 215 can be a virtual representation of the physical object 235, or can be a target object as described with respect to FIG. 1. The AR system 200 can correlate movement of the physical object controller 235 in the real-world space 230 with positional manipulation of the virtual object 215 by attributing a fixed frame of reference to the real-world space 230, and then correlating coordinates of the physical object controller 235 with coordinates of the virtual object 215 in the VR environment. In some implementations, software associated with the AR system 200 and executable by one or more processors of the computer system 210 can use the image capture device 211 to automatically recognize the real-world space 230, assign positional coordinates to the physical object controller 235 and to a number of reference points in the real-world space 230, correlate the positional coordinates of the physical object controller 235 with virtual coordinates of the virtual object 215 within the VR environment 220, and correlate the positional coordinates of the reference points in the real-world space 230 to virtual coordinates of one or more corresponding virtual reference points within the VR environment 220. Correlations between the real-world positional coordinates and the virtual coordinates may allow movements of the virtual object 215 presented in the VR environment 220 to seamlessly track movements of the physical object controller 235 in the real-world space 230.

The AR system 200 can recognize particular movements of the physical object controller 235 as user gestures, and can assign one or more operations to each of the recognized user gestures. In some implementations, the AR system 200 can cause a particular manipulation of the virtual object 215 in response to a corresponding one of the recognized user gestures. For one example, when the AR system 200 detects a circular gesture made by the physical object controller 235, the AR system 200 can rotate the virtual object 215 presented in the VR environment 220 (or cause any other suitable manipulation of the virtual object 215). For another example, when the AR system 200 detects a swiping gesture made by the physical object controller 235, the AR system 200 can move the virtual object 215 off the display screen 212 (or cause any other suitable manipulation of the virtual object 215). In addition, or in the alternative, the AR system 200 can perform one or more particular operations in response to a corresponding one of the recognized user gestures. For one example, when the AR system 200 detects a circular gesture made by the physical object controller 235, the AR system 200 can perform a first specified operation (such as refreshing the VR environment 220). For another example, when the AR system 200 detects a swiping gesture made by the physical object controller 235, the AR system 200 can perform a second specified operation (such as closing a software program).

In some implementations, the AR system 200 can use one or more relational parameters when translating movements of the physical object controller 235 in the real-world space 230 into movements of the virtual object 215 in the VR environment 220. The relational parameters, which can be retrieved from memory or received from the user, can define an N-to-1 movement ratio between detected movement of the physical object controller 235 in the real-world space 230 and positional manipulation of the virtual object 215 in the VR environment 220, where N is a real number (such as an integer greater than zero). For example, in instances for which N=2, an amount of change in a particular characteristic of the physical object controller 235 can cause N=2 times the amount of change in that particular characteristic of the virtual object 215. In some aspects, the user can move the physical object controller 235 by a certain amount to cause twice the amount of movement of the virtual object 215 in the VR environment 220. In other aspects, the user can rotate the physical object controller 235 by 180° clockwise, and cause the virtual object 215 to rotate within the VR environment 220 by 180° clock-wise at twice the rotational speed as the physical object controller 235. Many other examples too numerous to exhaustively list herein can be implemented by the AR systems disclosed herein.

In addition, or in the alternative, values provided by the user can define (at least in part) an audio taper relationship between the detected movement of the physical object controller 235 in real-world space 230 and the presentation of the virtual object 215 in the VR environment 220. The audio taper relationship may be a logarithmic scale mapping of position of the physical object controller 235 in the real-world space 230 to the representation of the virtual object 215 in the VR environment 220. That is, movement of the physical object controller 235 in the real-world space 230 can cause a corresponding movement, proportionate on a logarithmic scale, of the virtual object 215 in the VR environment 220.

In some implementations, the AR system 200 can identify (using the image capture device 211) an object held in or by the user's hand, and can generate a corresponding proportionate reaction in the VR environment 220. For example, if the user grabs and then moves the physical object controller 235 to the left, then the presentation of the virtual object 215 in the VR environment 220 moves to the left (such as towards the left edge of the display screen 212). The AR system 200 can also receive user parameters that further define the proportionality of the relationship between movements of the physical object controller 235 in the real-world space and corresponding manipulations of the virtual object 215 in the VR environment 220.

The AR system 200 can generate or receive a profile for the physical object 235. The profile can include any number of parameters, either retrieved from memory or learned from previous interactions with the physical object 235, that define certain tolerances and relationships between the physical object 235 and the virtual object 215. For example, the parameters can include the aforementioned relational parameters that define an N-to-1 movement ratio between movement of the physical object controller 235 and positional manipulation of the virtual object 215. The parameters can also include the aforementioned audio taper relationship, the movement tolerance range, or any other information specific to the physical object controller 235. In one or more implementations, the AR system 200 can generate or receive different profiles for a variety of physical objects suitable for use as the physical object controller 235.

In some implementations, the AR system 200 can be configured to detect more than a minimal change in position or orientation of the physical object controller 235 to trigger manipulation of the virtual object 215 in the VR environment 220. In some aspects, the minimal change may be based on the type or capabilities of hardware that implements the VR environment 220.

In some instances, the user's viewpoint or perspective can be moving relative to the physical object controller 235, which can also be moving. The AR system 200 can compensate for relative movements between the physical object controller 235 and the user's viewpoint using image recognition techniques to determine whether the physical object controller 235 is actually moving relative to the reference points generated for the real-world space 230. In some implementations, the AR system 200 can employ computationally-based error correction algorithms inclusive of various forms, iterations, and implementations of artificial intelligence (AI) or machine learning (ML) to predict, account for, and correct jostling or other inadvertent or unwanted movement of the physical object controller 235 such that any resulting manipulation of the virtual object 215 presented in the VR environment 220 remains true to range of motion or movement intended by the user. In this manner, the AR system 200 can more accurately translate movements of the physical object controller 235 into corresponding manipulations of the virtual object 215 as presented in the VR environment 220. For example, movement of birds or cars behind a window of a room used to define real-world space 230 can be identified and compensated for to prevent (or at least reduce) any interference with translating movement of the physical object controller 235 into manipulation of the virtual object 215.

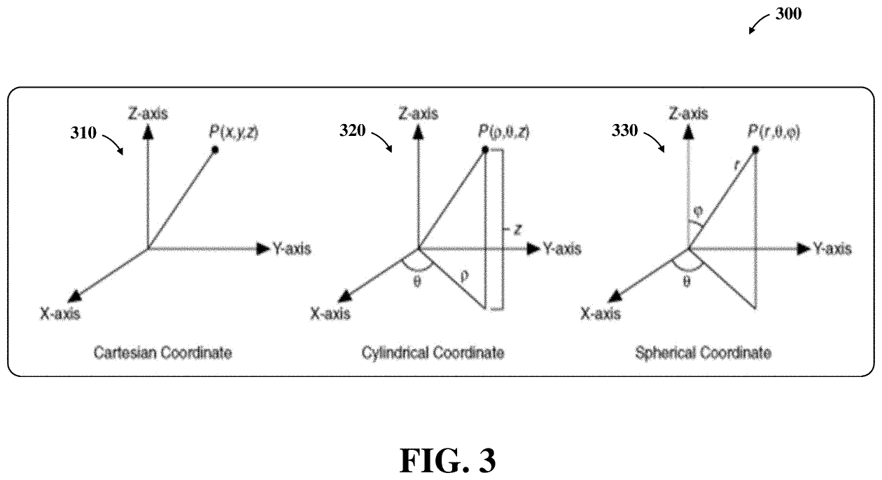

FIG. 3 shows a cartesian coordinate system 310, a cylindrical coordinate system 320, and a spherical coordinate system 330 that can be used by the AR systems disclosed herein to assign positional coordinates to physical object controllers, reference points, and other points or surfaces with the real-world space. The coordinates associated with the cartesian coordinate system 310, the cylindrical coordinate system 320, and the spherical coordinate system 330 can be real numbers, or can be complex numbers or elements of a more abstract system (such as a commutative ring) suitable for computer systems.

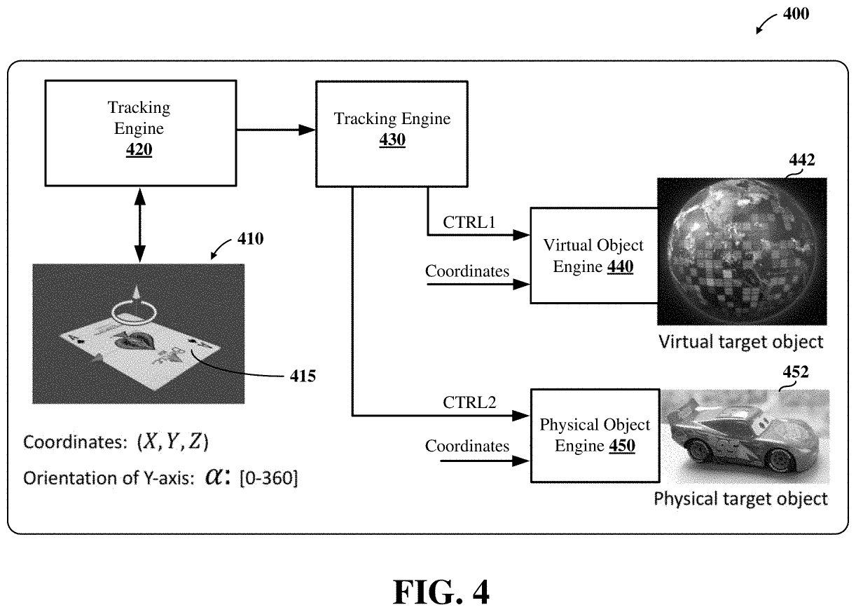

FIG. 4 shows an example process flow 400 for manipulating virtual and physical objects, according to some implementations. The example process flow 400 can be performed by any of the AR systems disclosed herein (such as the AR system 100 of FIG. 1 and the AR system 200 of FIG. 2). In some implementations, the AR system can determine or assign coordinates in the x, y, and z axes to the physical object controller, reference points, and other points or surfaces in the real-world space. For the example of FIG. 4, the angle (α) is defined relative to the y-axis. In other implementations, the angle (α) can be defined relative to either the x-axis or the z-axis.

The AR system 400 is shown to include a real-world space 410, a tracking engine 420, a positioning engine 430, a virtual object engine 440, and a physical object engine 450. In some implementations, one or more of the engines 420, 430, 440, and 450 can be or include system run-time components which implement of at least some portions of an execution model. Also, the particular placement and ordering of the various components of the process flow 400 are merely illustrative; in other implementations, the process flow 400 may include fewer components, more components, additional components, or a different ordering of the components shown in FIG. 4.

The real-world space 410 is shown to include a playing card used as a physical object controller 415. The tracking engine 420 can be used to detect and track the physical object controller 415 (or any other physical object to be used as a physical object controller). Although not shown for simplicity, the tracking engine 420 can include one or more image capture devices that capture images or video of the physical object controller 415. In some implementations, the tracking engine 420 can employ C# script in Unity to capture images or video of a physical object and designate the physical object as a controller for the AR system 400.

The positioning engine 430 receives images or video of the physical object controller 415 from the tracking engine 420, and can generate various control signals in response thereto. More specifically, the positioning engine 430 can generate a first set of control signals (CTRL1) for the virtual object engine 440, and can generate a second set of control signals (CTRL2) for the physical object engine 450. Each of the first and second sets of control signals CTRL1-CTRL2 can include information indicative of detected movements of the physical object controller 415.

The virtual object engine 440 can be used to manipulate a virtual object 442 based on movements of the physical object controller 415. The virtual object 442 may be presented in any suitable VR environment. The physical object engine 450 can be used to manipulate a physical object 452 based on movements of the physical object controller 415. The physical object 452 can be any suitable object, device, or item. Thus, although depicted in the example of FIG. 4 as a toy car, the physical object 452 can be other suitable objects. In some implementations, a user can control the speed, direction, and other aspects of the physical object 452 using the playing card as the physical object controller 415.

In some aspects, a system run-time environment associated with the process flow 400 may include the following commands relating to the registration, exposure, attribution, and transmission of the control signals CTRL1 and CTRL2:
register( )—register this target to system run-time to receive signals;
unregister( )—remove this target from system run-time;
expose( )—expose target's capabilities or properties that can be controlled;
link(attribute)—map the signals to particular capabilities or properties to be controlled; and
send(signals)—deliver signals to target, and target shall react to it accordingly

Those skilled in the art will appreciate that the above-listed commands are provided by way of example only, and that other suitable commands may be used.

As mentioned above, the AR systems disclosed herein allow a user to select or change the color of a virtual object using a physical object that does not need to exchange signals or actively communicate with the AR system. By allowing a user to select or change the color of a virtual object using any one of a wide variety of non-electronic physical objects commonly found at home or work (such as a roll-up newspaper, a book, a playing card, and so on), the AR systems disclosed herein may not only be more user-friendly than conventional voice-based VR systems but may also increase the range of possible colors that can be selected by the user.

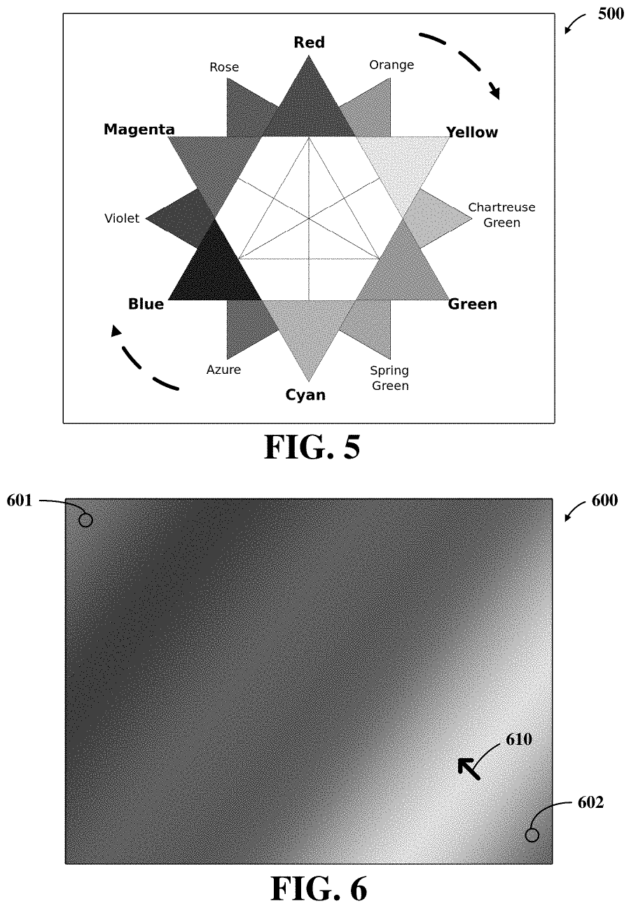

For example, FIG. 5 shows an example color wheel 500 that can be used by conventional voice-based VR systems to select the color of a virtual object. The color wheel 500 displays a finite number of colors and their names. The user of a conventional voice-based VR system may select a color for a virtual object by speaking the name of the color, and in response thereto, the conventional voice-based VR system may assign the corresponding color of the color wheel 500 to the virtual object. However, because the number of colors having commonly-known names is finite, the selection of colors using conventional voice-based VR systems may be limited, and changing the color of the virtual object using such conventional voice-based VR systems may be limited to discrete or incremental color changes.

FIG. 6 shows an example color map 600 that can be used to select or change the color of a virtual object using the AR systems disclosed herein. In accordance with some aspects of the present disclosure, a user can employ the physical object controller to move a virtual pointer 610 around the continuous spectrum of colors displayed in the color map 600, and select a particular color shade without knowing a specific name or color mixture of the selected color shade. More specifically, the user can move or rotate the physical object controller in a manner that moves the virtual pointer 610 around the color map 600 until a desired color is selected. For example, color selection of a virtual object may begin with selecting a light blue color 601, and may gradually shift towards a bright green color 602. In some aspects, the color map 600 can be presented to the user in a VR environment (such as the VR environment 120 of FIG. 1 or the VR environment 220 of FIG. 2). In other aspects, the color map 600 can be presented to the user on a suitable display screen (such as the display screen 212 of FIG. 2). In this manner, the AR systems disclosed herein can provide a near-infinite number of colors from which the user can select for the virtual object in an easy-to-control and user-friendly manner.

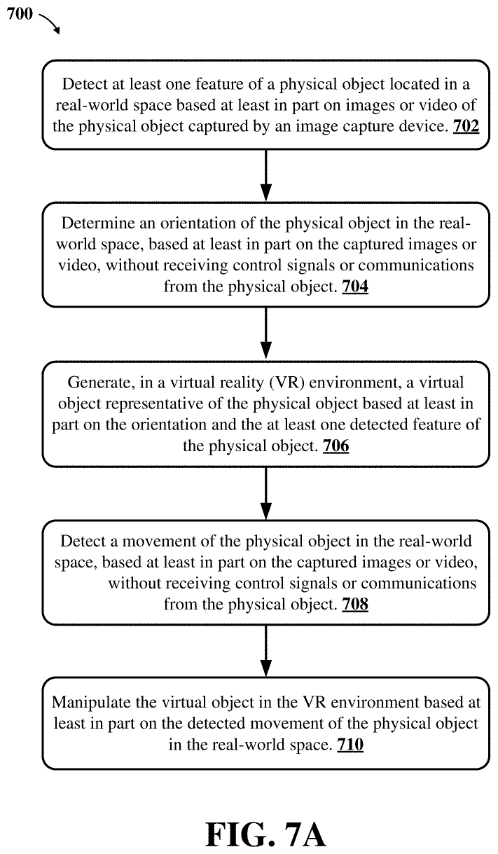

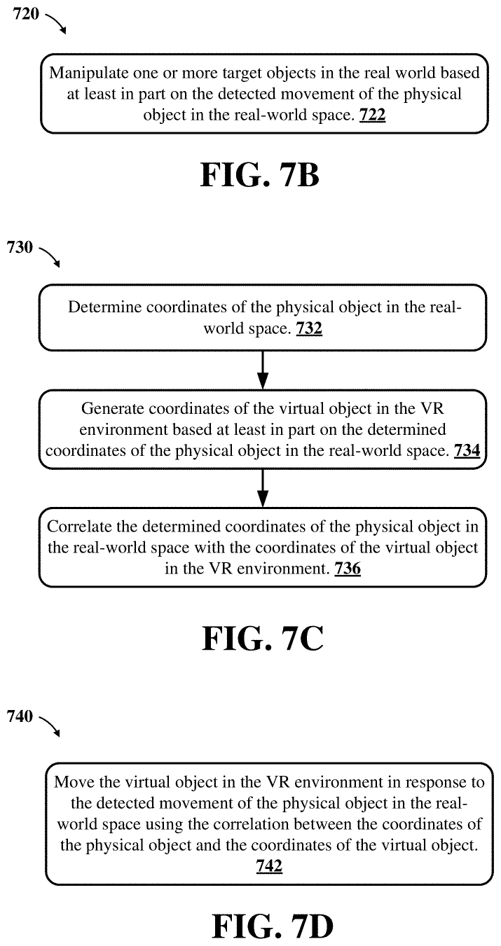

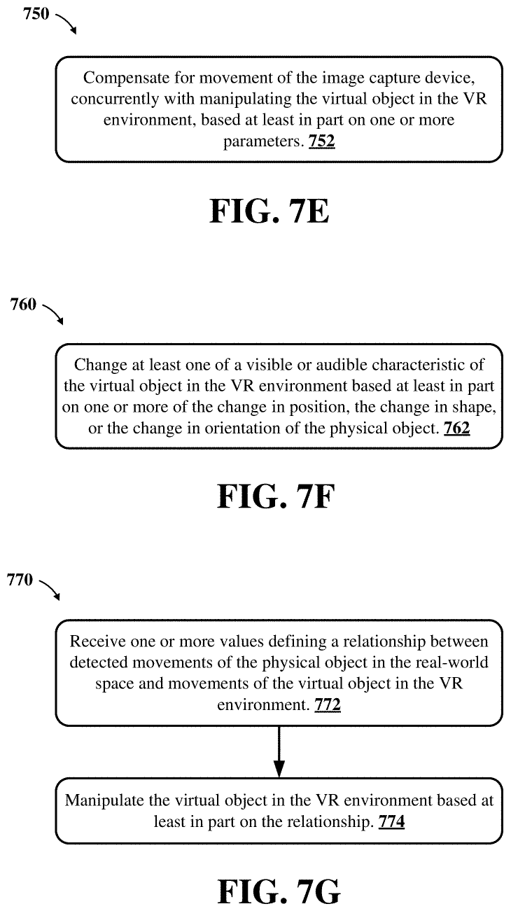

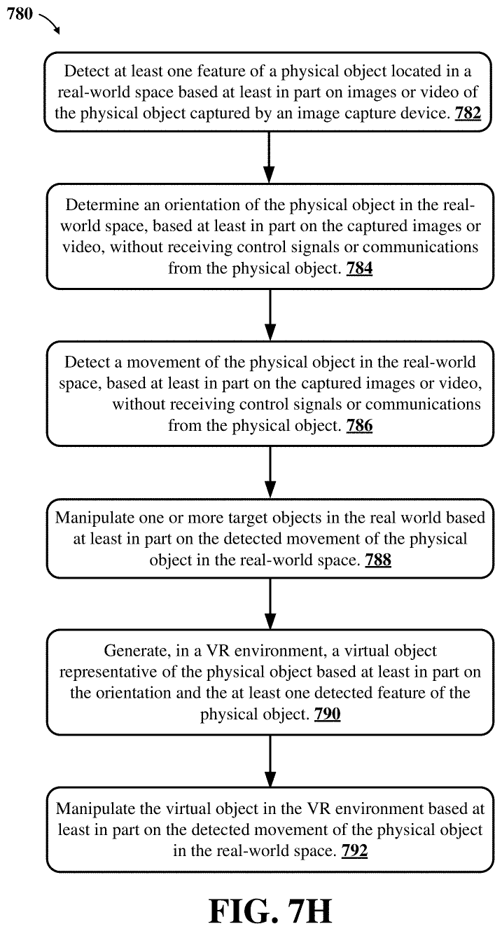

FIG. 7A shows an illustrative flowchart depicting an example operation 700 for manipulating a virtual object in a virtual reality (VR) environment, according to some implementations. The operation 700 may be performed by one or more processors of an augmented reality (AR) system such as the AR system 100 of FIG. 1 or the AR system 200 of FIG. 2. At block 702, the AR system detects at least one feature of a physical object located in a real-world space based at least in part on images or video of the physical object captured by an image capture device. At block 704, the AR system determines an orientation of the physical object in the real-world space, based at least in part on the captured images or video, without receiving control signals or communications from the physical object. At block 706, the AR system generates, in a virtual reality (VR) environment, a virtual object representative of the physical object based at least in part on the orientation and the at least one detected feature of the physical object. At block 708, the AR system detects a movement of the physical object in the real-world space, based at least in part on the captured images or video, without receiving control signals or communications from the physical object. At block 710, the AR system manipulates the virtual object in the VR environment based at least in part on the detected movement of the physical object in the real-world space.

The AR system does not need to receive control signals or communications from the physical object to determine the orientation of the physical object in the real-world space or to detect movement of the physical object in the real-world space. In some implementations, the physical object can be incapable of exchanging signals or communicating with the AR system or the image capture device. As such, the physical object can be any one of a wide variety of non-electronic objects or items commonly found in a user's home or work. For example, the physical object can be an ordinary non-electronic item or object including (but not limited to) a book, a magazine, rolled-up newspaper, a playing card, a glass, a plate, a bottle, a ball, a toy car, a utensil, a throw-pillow, a paperweight, a hand or fingers, and so on. In other aspects, the physical object can be capable of exchanging signals or communicating with the AR system or the image capture device, but the AR system may not receive any control signals or communications from the physical object (or may not use any signals or communications from the physical object to determine the orientation of the physical object, to detect movement of the physical object, or to control other aspects of the AR system). For example, in one or more implementations, a smartphone may be used as the physical object controller for the AR system, and can be turned off or otherwise disabled when used as the physical object controller for the AR system; in the event that the smartphone is not turned off or disabled, any signals or communications transmitted by the smartphone will not be received, nor used in any manner, by the AR system.

In some implementations, movement of the physical object in the real-world space can include a gesture, and manipulating the virtual object can include changing at least one characteristic of the virtual object based at least in part on the gesture. In some aspects, changing the at least one characteristic of the virtual object can include at least one of changing a position of the virtual object, changing an orientation of the virtual object, changing a shape of the virtual object, or changing a color of the virtual object based on the gesture. In some other implementations, movement of the physical object may include one or more of a change in position, a change in shape, or a change in orientation of the physical object in the real-world space.

FIG. 7B shows an illustrative flowchart depicting an example operation 720 for manipulating a virtual object in a VR environment, according to some implementations. The operation 720 may be performed by one or more processors of an AR system such as the AR system 100 of FIG. 1 or the AR system 200 of FIG. 2. In some implementations, the operation 720 may begin after manipulating the virtual object in block 710 of FIG. 7A. In other implementations, the operation 720 may begin before manipulating the virtual object in block 710 of FIG. 7A. In some other implementations, the operation 720 may be performed concurrently with manipulating the virtual object in block 710 of FIG. 7A. At block 722, the AR system manipulates one or more target objects in the real world based at least in part on the detected movement of the physical object in the real-world space. For example, in some implementations, the target object can be a pointer that can be used to manipulate or control other objects or devices in the real world.

FIG. 7C shows an illustrative flowchart depicting an example operation 730 for manipulating a virtual object in a VR environment, according to some implementations. The operation 730 may be performed by one or more processors of an AR system such as the AR system 100 of FIG. 1 or the AR system 200 of FIG. 2. In some implementations, the operation 730 may be an example of generating the virtual object in block 706 of FIG. 7A. At block 732, the AR system determines coordinates of the physical object in the real-world space. At block 734, the AR system generates coordinates of the virtual object in the VR environment based at least in part on the determined coordinates of the physical object in the real-world space. At block 736, the AR system correlates the determined coordinates of the physical object in the real-world space with the coordinates of the virtual object in the VR environment. In some aspects, the coordinates of the physical object may be relative to the AR system or to some other fixed object or point in the real-world space. In other aspects, the coordinates of the physical object may be absolute coordinates determined by or received from a suitable GPS device. In some other aspects, the AR system can attribute or assign coordinates to regions, surface areas, objects, and reference points within the real-world space (such as the physical object 135 and reference points 131-134 of FIG. 1). Correlations between the real-world coordinates and the VR environment coordinates may allow movements of virtual objects presented in the VR environment to seamlessly track movements of the physical object controller in the real-world space.

FIG. 7D shows an illustrative flowchart depicting an example operation 740 for manipulating a virtual object in a VR environment, according to some implementations. The operation 740 may be performed by one or more processors of an AR system such as the AR system 100 of FIG. 1 or the AR system 200 of FIG. 2. In some implementations, the operation 740 may be an example of manipulating the virtual object in block 710 of FIG. 7A. At block 742, the AR system moves the virtual object in the VR environment in response to the detected movement of the physical object in the real-world space using the correlation between the coordinates of the physical object and the coordinates of the virtual object. In some implementations, the AR system can cause the virtual object to move within the VR environment in concert with movements of the physical object controller in the real-world space. In other implementations, the AR system can cause proportional movements of the virtual object within the VR environment based on the movements of the physical object controller. For example, in some aspects, the AR system can use a relationship between detected movements of the physical object in the real-world space and movements of the virtual object in the VR environment when moving the virtual object in the VR environment based on movements of the physical object in the real-world space.

FIG. 7E shows an illustrative flowchart depicting an example operation 750 for manipulating a virtual object in VR environment, according to some implementations. The operation 750 may be performed by one or more processors of an AR system such as the AR system 100 of FIG. 1 or the AR system 200 of FIG. 2. In some implementations, the operation 750 may begin prior to detecting the physical object in block 702 of FIG. 7A. In other implementations, the operation 750 may begin after manipulating the virtual object in block 710 of FIG. 7A. In some other implementations, the operation 750 may begin at any time during the example operation 700 of FIG. 7A. At block 752, the AR system compensates for movement of the image capture device, concurrently with manipulating the virtual object in the VR environment, based at least in part on one or more parameters. In some aspects, the one or more parameters can be provided by a user, for example, via the I/O interface 214 of FIG. 2. In other aspects, the one or more parameters can be generated, determined, or selected by the AR system.

In some implementations, the AR system can compensate for inadvertent or non-deliberate movements of the image capture device by selectively adjusting perceived movements of the physical object. For example, if the user accidently bumps into the image capture device and causes it to inadvertently move, even temporarily, the AR system can determine an amount by which the image capture device moved and then adjust the perceived movements of the physical object based on the determined amount. In this manner, the AR system can ignore accidental movements of the image capture device, rather than causing movement or other manipulations of the virtual object based on such accidental movements, thereby improving user experience.

FIG. 7F shows an illustrative flowchart depicting an example operation 760 for manipulating a virtual object in a VR environment, according to some implementations. The operation 760 may be performed by one or more processors of an AR system such as the AR system 100 of FIG. 1 or the AR system 200 of FIG. 2. In some implementations, the operation 760 may be an example of manipulating the virtual object in block 710 of FIG. 7A. At block 762, the AR system can manipulate the virtual object by changing at least one of a visible or audible characteristic of the virtual object in the VR environment based on one or more of a change in position, a change in shape, or a change in orientation of the physical object. In some aspects, the at least one visible or audible characteristic includes one or more of a color of the virtual object, a brightness of the virtual object, a shape of the virtual object, a position of the virtual object, or a size of the virtual object.

FIG. 7G shows an illustrative flowchart depicting an example operation 770 for manipulating a virtual object in a VR environment, according to some implementations. The operation 770 may be performed by one or more processors of an AR system such as the AR system 100 of FIG. 1 or the AR system 200 of FIG. 2. In some implementations, the operation 770 may be performed in conjunction with manipulating the virtual object in block 710 of FIG. 7A. At block 772, the AR system receives one or more values defining a relationship between detected movements of the physical object in the real-world space and movements of the virtual object in the VR environment. At block 774, the AR system manipulates the virtual object in the VR environment based at least in part on the relationship.

In some implementations, the relationship can be a relationship defining a logarithmic scale mapping between the detected movements of the physical object in the real-world space and the movements of the virtual object in the VR environment. In other implementations, the relationship can define an N-to-1 movement ratio between detected movement of the physical object controller in the real-world space and positional manipulation of the virtual object in the VR environment, where N is a real number (such as an integer greater than zero). In some other implementations, other suitable relationships or mappings between movements of the physical object in the real-world space and movements of the virtual object in the VR environment can be used by the AR system. In some aspects, the relationship can be provided by a user, for example, via the I/O interface 214 of FIG. 2. In other aspects, the relationship can be retrieved from a suitable memory associated with the AR system. In some other aspects, the relationship can be generated or determined by the AR system.

FIG. 7H shows an illustrative flowchart depicting an example operation 780 for manipulating a virtual object in VR environment, according to some implementations. The operation 780 may be performed by one or more processors of an AR system such as the AR system 100 of FIG. 1 or the AR system 200 of FIG. 2. At block 782, the AR system detects at least one feature of a physical object located in a real-world space based on images or video of the physical object captured by an image capture device. At block 784, the AR system determines an orientation of the physical object in the real-world space, based at least in part on the captured images or video, without receiving control signals or communications from the physical object. At block 786, the AR system detects a movement of the physical object in the real-world space, based at least in part on the captured images or video, without receiving control signals or communications from the physical object. At block 788, the AR system manipulates one or more target objects in the real world based at least in part on the detected movement of the physical object in the real-world space.

The AR system does not need to receive control signals or communications from the physical object to determine the orientation of the physical object in the real-world space or to detect movement of the physical object in the real-world space. In some implementations, the physical object can be incapable of exchanging signals or communicating with the AR system or the image capture device. As such, the physical object can be any one of a wide variety of non-electronic objects or items commonly found in a user's home or work. For example, the physical object can be an ordinary non-electronic item or object including (but not limited to) a book, a magazine, rolled-up newspaper, a playing card, a glass, a plate, a bottle, a ball, a toy car, a utensil, a throw-pillow, a paperweight, a hand or fingers, and so on. In other aspects, the physical object can be capable of exchanging signals or communicating with the AR system or the image capture device, but the AR system may not receive any control signals or communications from the physical object (or may not use any signals or communications from the physical object to determine the orientation of the physical object, to detect movement of the physical object, or to control other aspects of the AR system). For example, in one or more implementations, a smartphone may be used as the physical object controller for the AR system, and can be turned off or otherwise disabled when used as the physical object controller for the AR system; in the event that the smartphone is not turned off or disabled, any signals or communications transmitted by the smartphone will not be received, nor used in any manner, by the AR system.

In some implementations, movement of the physical object in the real-world space can include a gesture, and manipulating the virtual object can include changing at least one characteristic of the virtual object based at least in part on the gesture. In some aspects, changing the at least one characteristic of the virtual object can include at least one of changing a position of the virtual object, changing an orientation of the virtual object, changing a shape of the virtual object, or changing a color of the virtual object based on the gesture. In some other implementations, movement of the physical object may include one or more of a change in position, a change in shape, or a change in orientation of the physical object in the real-world space.

In some implementations, the operation 780 can include one or more additional processes. For example, at block 790, the AR system can generate, in a VR environment, a virtual object representative of the physical object based at least in part on the orientation and the at least one detected feature of the physical object. At block 792, the AR system can manipulate the virtual object in the VR environment based at least in part on the detected movement of the physical object in the real-world space. In some implementations, movement of the physical object in the real-world space can include a gesture, and manipulating the virtual object can include changing at least one characteristic of the virtual object based on the gesture. In some aspects, changing the at least one characteristic of the virtual object can include at least one of changing a position of the virtual object, changing an orientation of the virtual object, changing a shape of the virtual object, or changing a color of the virtual object based on the gesture. In some other implementations, movement of the physical object may include one or more of a change in position, a change in shape, or a change in orientation of the physical object in the real-world space.

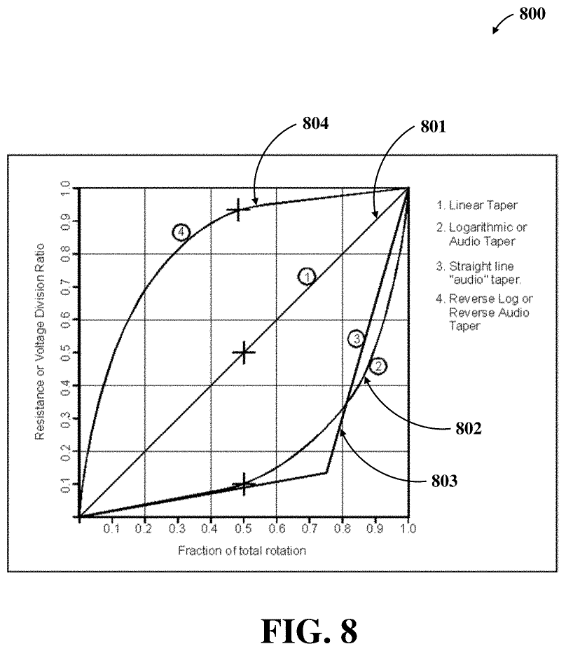

FIG. 8 shows an example audio taper plot 800, according to some implementations. The audio taper plot 800 may define one or more relationships 801-804 between movement of the physical object controller 235 in the real-world space and manipulation of the virtual object 215 presented in the VR environment. A first relationship 801 depicts a linear taper in which movement of the physical object controller 235 in the real-world space causes a corresponding equal movement of the virtual object 215 presented in the VR environment. For example, the first relationship 801 can be employed in implementations for which the user selects or changes the color of a virtual object based on movements of the physical object controller, as depicted in FIG. 6.

A second relationship 802 depicts a logarithmic taper in which movement of the physical object controller 235 in the real-world space causes a corresponding exponential movement of the virtual object 215 presented in the VR environment. A third relationship 803 depicts a straight line “audio” taper in which movement of the physical object controller 235 in the real-world space causes a gradual movement of the virtual object 215 presented in the VR environment. A fourth relationship 804 depicts a reverse logarithmic taper in which movement of the physical object controller 235 in the real-world space causes a corresponding inverse exponential movement of the virtual object 215 presented in the VR environment.

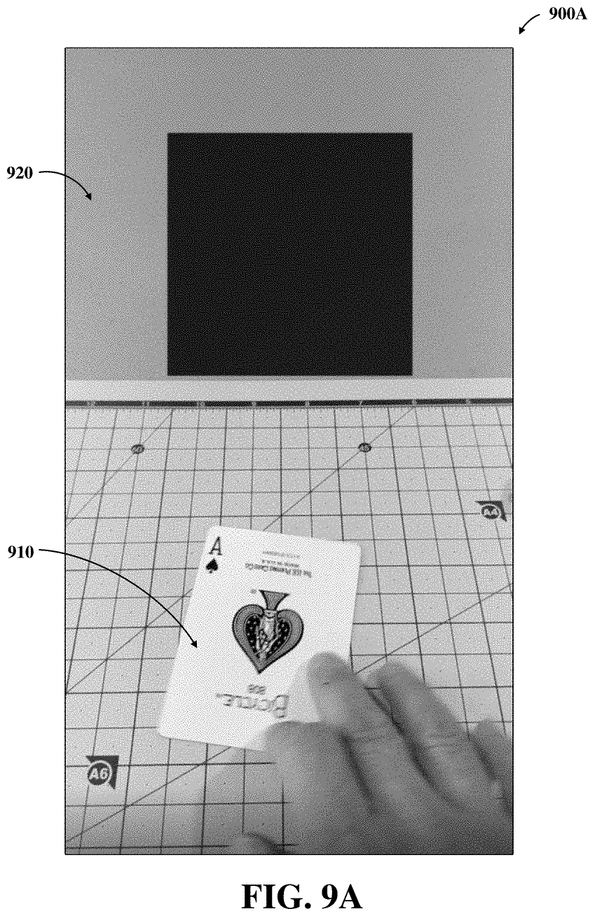

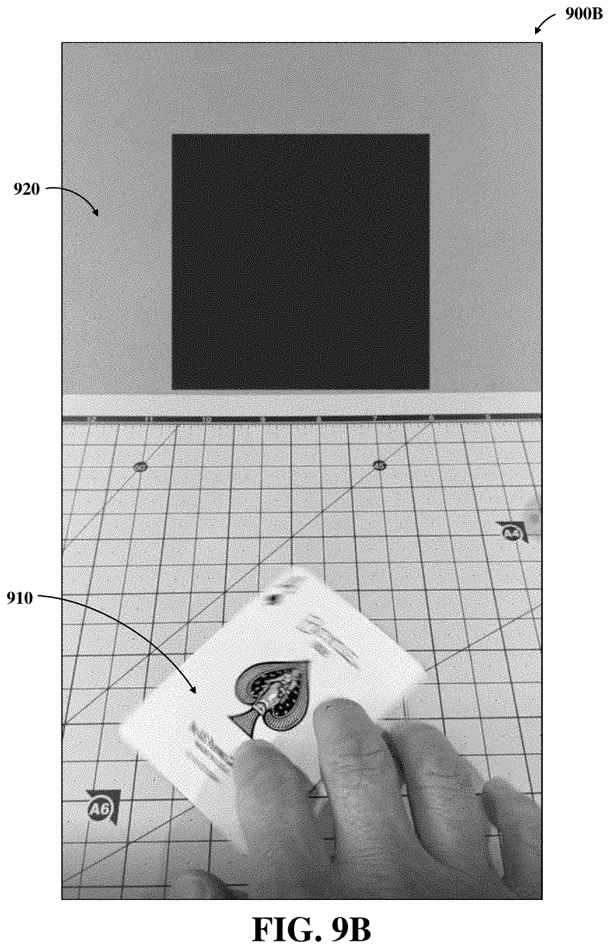

FIG. 9A shows an illustration 900A depicting an example operation for manipulating a virtual object, according to some implementations. More specifically, the illustration 900A depicts a user employing a playing card 910 as a physical object controller to change the color of a virtual object as presented in a VR environment 920. As shown in FIG. 9A, the VR environment 920 initially displays a particular shade of blue as the selected color of the virtual object. The user may rotate the playing card 910 in the real-world space to change the selected color of the virtual object. For example, FIG. 9B shows an illustration 900B depicting the VR environment 920 changing the selected color of the virtual object from the shade blue of FIG. 9A to a shade of red based on detection of the rotation of the playing card 910. Although not shown in FIGS. 9A and 9B for simplicity, in some implementations, the VR environment 920 may display the color map 600 of FIG. 6, and rotation of the playing card 910 may cause movement of a pointer (such as the pointer 610 of FIG. 6) to select or change the color of the virtual object.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for generating a virtual reality (VR) environment, the method performed by one or more processors of a computer system and comprising:
detecting one or more features of a physical object located in a real-world space based on images or video of the physical object captured by an image capture device;
designating the physical object as a controller of the VR environment based on the detected features of the physical object;
determining an orientation of the physical object in the real-world space based on the captured images or video without receiving control signals or communications from the physical object;
generating, in the VR environment, a virtual object representative of the physical object based on the orientation and the one or more detected features of the physical object;
detecting a gesture associated with the physical object in the real-world space based on the captured images or video without receiving control signals or communications from the physical object; and
changing a position or orientation of the virtual object in the VR environment based on the detected gesture.

2. The method of claim 1, wherein the physical object is incapable of transmitting signals or communications to the system.

3. The method of claim 1, wherein the generating includes:
presenting the virtual object on a display screen viewable by a user associated with the physical object.

4. The method of claim 3, further comprising:
determining that the detected gesture is a swiping gesture; and
moving the virtual object off the display screen in response to the swiping gesture.

5. The method of claim 4, further comprising:
associating the virtual object with one or more software programs executing on the system; and
closing the one or more executing software programs in response to the swiping gesture.

6. The method of claim 3, further comprising:
determining that the detected gesture is a circular gesture; and
moving the virtual object in a circle around the display screen in response to the circular gesture.

7. The method of claim 3, wherein the changing includes:
changing the position or orientation of the virtual object presented on the display screen based on the detected gesture.

8. The method of claim 7, wherein the virtual object comprises a virtual pointer, the method further comprising:
presenting a continuous spectrum of colors in a circular orientation on the display screen;
moving the virtual pointer around the continuous spectrum of colors on the display screen based on the detected gesture; and
selecting a color of the continuous spectrum of colors based on the movement of the virtual pointer around the continuous spectrum of colors.

9. The method of claim 1, further comprising:
associating the physical object with a user; and
compensating for movement of the image capture device, concurrently with changing the position or orientation of the virtual object in the VR environment, in response to one or more parameters provided by the user.

10. The method of claim 1, further comprising:
receiving, from a user, one or more values defining a relationship between detected movements of the physical object in the real-world space and movements of the virtual object in the VR environment; and
manipulating the virtual object in the VR environment based at least in part on the relationship.

11. A system for generating a virtual reality (VR) environment, the system comprising:
an image capture device configured to capture images or video of a physical object located in a real-world space;
one or more processors; and
a memory coupled to the one or more processors and storing instructions that, when executed by the one or more processors, cause the system to:
detect one or more features of a physical object located in a real-world space based on images or video of the physical object captured by an image capture device;
designate the physical object as a controller of the VR environment based on the detected features of the physical object;
determine an orientation of the physical object in the real-world space based on the captured images or video without receiving control signals or communications from the physical object;
generate, in the VR environment, a virtual object representative of the physical object based on the orientation and the one or more detected features of the physical object;
detect a gesture associated with the physical object in the real-world space based on the captured images or video without receiving control signals or communications from the physical object; and
change a position or orientation of the virtual object in the VR environment based on the detected gesture.

12. The system of claim 11, wherein the physical object is incapable of transmitting signals or communications to the system.

13. The system of claim 11, wherein execution of the instructions to generate the virtual object causes the system to:
present the virtual object on a display screen viewable by a user associated with the physical object.

14. The system of claim 13, wherein execution of the instructions further causes the system to:
determine that the detected gesture is a swiping gesture; and
move the virtual object off the display screen in response to the swiping gesture.

15. The system of claim 14, wherein execution of the instructions further causes the system to:
associate the virtual object with one or more software programs executing on the system; and
close the one or more executing software programs in response to the swiping gesture.

16. The system of claim 13, wherein execution of the instructions further causes the system to:
determine that the detected gesture is a circular gesture; and
move the virtual object in a circle around the display screen in response to the circular gesture.

17. The system of claim 13, wherein execution of the instructions to change the position or orientation further causes the system to:
change the position or orientation of the virtual object presented on the display screen based on the detected gesture.

18. The system of claim 17, wherein the virtual object comprises a virtual pointer, and execution of the instructions further causes the system to:
present a continuous spectrum of colors in a circular orientation on the display screen;
move the virtual pointer around the continuous spectrum of colors on the display screen based on the detected gesture; and
select a color of the continuous spectrum of colors based on the movement of the virtual pointer around the continuous spectrum of colors.

19. The system of claim 11, wherein execution of the instructions further causes the system to:
associate the physical object with a user; and
compensate for movement of the image capture device, concurrently with changing the position or orientation of the virtual object generated in the VR environment, in response to one or more parameters provided by the user.

20. The system of claim 11, wherein execution of the instructions further causes the system to:
receive, from a user, one or more values defining a relationship between detected movements of the physical object in the real-world space and movements of the virtual object in the VR environment; and
manipulate the virtual object in the VR environment based at least in part on the relationship.
